(19) United States
(12) Patent Application Publication
(10) Pub. No.: US 2025/0350013 A1
(43) Pub. Date: Nov. 13, 2025

(54) ELECTRICAL INTERCONNECTION ELEMENT, HIGH-FREQUENCY WAVEGUIDE MODULE, ELECTRICAL APPARATUS

(71) Applicant: Rohde & Schwarz GmbH & Co. KG, München (DE)

(72) Inventors: Jens GOLIASCH, Bonn (DE); Bertrand THOMAS, Rheinbach (DE); Ralf HENNEBERGER, Meckenheim (DE)

(21) Appl. No.: 18/662,356

(22) Filed: May 13, 2024

(51) Int. Cl. H01P 5/08; H01P 3/12

(52) U.S. Cl. CPC H01P 5/08; H01P 3/12

(57) ABSTRACT

The present disclosure provides an electrical interconnection element comprising a first connection section for electrically coupling to a first electric circuit, a second connection section for electrically coupling to a second electric circuit, and a coupling section, wherein the first connection section, the coupling section, and the second connection section are arranged next to each other in a first, longitudinal direction of the electrical interconnection element, and are electrically coupled to each other, and wherein the first connection section in a second direction that is orthogonal to the first direction is wider than the second connection section in the second direction. Further, the present disclosure provides a high-frequency waveguide module, and an electrical apparatus.

### TECHNICAL FIELD

The disclosure relates to an electrical interconnection element, a high-frequency waveguide module, and an electrical apparatus.

### BACKGROUND

Although applicable to any type of high frequency electrical device, the present disclosure will mainly be described in conjunction with Monolithic Microwave Integrated Circuits, MMICs.

MMICs may be integrated with other electrical components, like antennas, in electrical applications.

When coupling MMICs to the respective electrical components, losses need to be reduced in order to improve the system performance.

Accordingly, there is a need for an improved coupling of electrical components.

### SUMMARY

The above stated problem is solved by the features of the independent claims. It is understood, that independent claims of a claim category may be formed in analogy to the dependent claims of another claim category.

Accordingly, it is provided:

An electrical interconnection element comprising a first connection section for electrically coupling to a first electric circuit, a second connection section for electrically coupling to a second electric circuit, and a coupling section, wherein the first connection section, the coupling section, and the second connection section are arranged next to each other in a first, longitudinal direction of the electrical interconnection element, and are electrically coupled to each other, and wherein the first connection section in a second direction that is orthogonal to the first direction is wider than the second connection section in the second direction.

Further, it is provided:

A high-frequency waveguide module comprising a first electric circuit, a second electric circuit arranged in a predefined distance, which may be zero or larger, from the first electric circuit, and an electrical interconnection element, the electrical interconnection element comprising a first connection section electrically coupled to the first electric circuit, a second connection section electrically coupled to the second electric circuit, and a coupling section, wherein the first connection section, the coupling section, and the second connection section are arranged next to each other in a first, longitudinal direction of the electrical interconnection element, and are electrically coupled to each other, and wherein the first connection section in a second direction that is orthogonal to the first direction is wider than the second connection section in the second direction.

Further, it is provided:

An electrical apparatus comprising a first electric circuit, a second electric circuit arranged in a predefined distance from the first electric circuit, and an electrical interconnection element, the electrical interconnection element comprising, a first connection section electrically coupled to the first electric circuit, a second connection section electrically coupled to the second electric circuit, and a coupling section, wherein the first connection section, the coupling section, and the second connection section are arranged next to each other in a first, longitudinal direction of the electrical interconnection element, and are electrically coupled to each other, and wherein the first connection section in a second direction that is orthogonal to the first direction is wider than the second connection section in the second direction, the electrical apparatus further comprising a first substrate, and a second substrate, wherein the first electric circuit is arranged on the first substrate, wherein the first electric circuit comprises a first electrical connection pad, wherein the first electrical connection pad is electrically coupled to the first connection section of the electrical interconnection element, wherein the second electric circuit is arranged on the second substrate, wherein the second electric circuit comprises a second electrical connection pad, and wherein the second electrical connection pad is electrically coupled to the second connection section of the electrical interconnection element.

The electrical apparatus may e.g., be a satellite, a radiometer, a microwave transmitter, or a microwave receiver.

The present disclosure is based on the finding that using simple wire bonds when coupling high frequency electrical elements to each other results in a degraded RF performance of the respective circuits.

The present disclosure in contrast, provides the electrical interconnection element in order to provide an improved impedance matching, decreased reflection losses, and no or less standing waves in the respective electrical circuits. The present disclosure, consequently, provides electrical circuits with an increased performance.

To this end, the present disclosure provides the electrical interconnection element. The electrical interconnection element may be seen as a pre-formed optimized interconnection element for interconnecting two different electrical elements or circuits in the respective application.

The electrical interconnection element comprises a first connection section, and a second connection section, that are linked or coupled to each other electrically via a coupling section.

The first connection section, the coupling section, and the second connection section are arranged in this order in a first, longitudinal direction of the electrical interconnection element. While the first direction defines the order of the first connection section, the coupling section, and the second connection section, this elements may be offset or displaced with respect to the axis defined by the first direction. In such embodiments, the axis defined by the first direction not necessarily defines the center axis of the three sections.

In a second direction that is orthogonal to the first direction, the first connection section, and the second connection section comprise different widths. The coupling section provides the transition between the width of the first connection section, and the width of the second connection section.

The electrical interconnection element may be used to coupled two electric elements in an application to each other instead of a single or multiple wire bonds.

By gradually adapting the width of the first connection section to the width of the second connection section with the coupling section, the electrical interconnection element provides a smooth transition with an improved impedance matching, reduced reflection losses and reduced standing waves.

The widths of the first connection section, and the second connection section may be adapted to the respective application. The length of the first connection section, the second connection section, and the coupling section may also be adapted to the respective application.

Using the electrical interconnection element improves the performance of multi-component electrical circuits and sub-systems by improving the interconnection between the single components. As indicated, the electrical interconnection element may be tailored to the transmission line dimensions in the single components to reduce the impedance steps between the single components.

In an exemplary embodiment, the width of the first connection section is 0.152 mm, the width of the second connection section is 0.051 mm. The length of the first connection section may be 0.152 mm, and the length of the second connection section may be 0.051 mm. In such an embodiment, the first connection section, and the second connection section may each be square-shaped. The coupling section may comprise a length of 0.051 mm and straight or curved edges from the first connection section to the second connection section. Such an electrical interconnection element may e.g., be formed of or covered with gold or aluminum with a thickness of e.g., 2-3 μm.

Other dimensions are also possible. For example, the width of the first connection section may be between 0.1 mm and 1 mm, especially between 0.05 mm and 0.25 mm, or between 0.1 mm and 0.2 mm. The width of the second connection section may be between 0.1 mm and 1 mm, especially between 0.05 mm and 0.25 mm, or between 0.01 mm and 0.1 mm. The length of the first connection section may be between 0.1 mm and 1 mm, especially between 0.05 mm and 0.25 mm, or between 0.1 mm and 0.2 mm. The length of the second connection section may be between 0.1 mm and 1 mm, especially between 0.05 mm and 0.25 mm, or between 0.01 mm and 0.1 mm. The first connection section, and the second connection section may be square shaped, rectangular shaped, or shaped with curved edges.

In embodiments, the surface of the electrical interconnection element may comprise holes, slots of cavities.

The specific dimensions or geometries of the electrical interconnection element may be specifically determined for each application by simulation.

The high-frequency waveguide module may comprise any one of the embodiments of the electrical interconnection element disclosed herein. The high-frequency waveguide module may e.g., comprise a transition from a wireless to a signal-line-based signal transmission e.g., from hollow waveguide to an electrical circuit, like a MMIC.

To this end, the high-frequency waveguide module may comprise a housing or multiple housing parts that accommodate the hollow waveguide, and the electrical circuit, like the MMIC. The electrical interconnection element may be provided in or fixed to the housing at the respective section, such that it may couple the hollow waveguide e.g., via an antenna provided in the hollow waveguide, to the electrical circuit.

The high-frequency waveguide module, and the electrical interconnection element may be used in any adequate application, like a satellite, a radiometer, a microwave transmitter, a microwave receiver, and mm-wave amplifiers, multipliers and mixers

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to independent claim 1 can be combined in all variations with each other and the disclosure of the description is not limited to the claim dependencies as specified in the claim set. Further, the features of the dependent claims referring to independent claim 1 may be combined with any of the features of the other independent claims or the dependent claims relating to any one of the other independent claims. Specifically, the high-frequency waveguide module, and the electrical apparatus may be combined with any one of the embodiments of the electrical interconnection element disclosed herein.

In an embodiment of the electrical interconnection element, which can be combined with all other embodiments mentioned above or below, the coupling section may in a plane defined by the first direction and the second direction comprise a shape that narrows from the width of the first connection section to the width of the second connection section.

As explained above, the coupling section serves for electrically coupling the first connection section to the second connection section with an electrically smooth transition i.e., especially without sudden changes in the impedance of the signal transmission path. This may be achieved by gradually or smoothly transitioning from the width of the first connection section to the width of the second connection section.

In another embodiment of the electrical interconnection element, which can be combined with all other embodiments mentioned above or below, the coupling section may in a plane defined by the first direction and the second direction comprise a trapezoidal shape, or a shape with curved edges from the first connection section to the second connection section.

With the trapezoidal shape, the coupling section comprises straight edges between the first connection section, and the second connection section. Such a shape is easy to manufacture.

Depending on the respective application, using curved edges may be beneficial. This may e.g., be determined with a respective simulation. The edges of the coupling section may in embodiments comprise any curved shape.

In a further embodiment of the electrical interconnection element, which can be combined with all other embodiments mentioned above or below, the first connection section, and the second connection section may in a plane defined by the first direction and the second direction each comprise a square shape, or a rectangular shape.

As explained exemplarily above, the first connection section, and the second connection section may comprise a square shape. In other embodiments, the first connection section, and the second connection section may comprise rectangular shapes that are wider than long, or longer than wide.

In further embodiments, the first connection section, and the second connection section may comprise non-rectangular shapes, like shapes that are at least in sections round or curved.

In an embodiment of the electrical interconnection element, which can be combined with all other embodiments mentioned above or below, the first connection section may electrically be coupled to the second connection section by at least one of bonding, ultrasonic bonding, soldering, and glueing. In addition, or as alternative, the second connection section may electrically be coupled to the coupling section by at least one of bonding, ultrasonic bonding, soldering, and glueing.

In such embodiments, the single sections of the electrical interconnection element may each be individually formed and may later be coupled to each other with any adequate method.

In another embodiment of the electrical interconnection element, which can be combined with all other embodiments mentioned above or below, the electrical interconnection element may comprise a single electrically conductive element that accommodates the first connection section, the second connection section, and the coupling section.

By forming all sections of the electrical interconnection element on a single electrically conductive element, manufacturing the electrical interconnection element is greatly simplified.

In an embodiment of the electrical interconnection element, which can be combined with all other embodiments mentioned above or below, the electrical interconnection element may at least one of be integrally formed, be formed of gold, or aluminum, and be formed by a photolithographic process.

Any adequate material may be used for the electrical interconnection element like e.g., gold or aluminum. Other electrically conductive materials are also possible.

Using a photolithographic process allows easily forming the electrical interconnection element according to an application's requirements.

In a further embodiment of the high-frequency waveguide module, which can be combined with all other embodiments mentioned above or below, the high-frequency waveguide module may further comprises a first substrate, wherein the first electric circuit may be arranged on the first substrate, and wherein the first electric circuit may comprise a first electrical connection pad, and wherein the first electrical connection pad may electrically be coupled to the first connection section of the electrical interconnection element.

The high-frequency waveguide module may comprise a dedicated substrate for the first electric circuit. The substrate may be any type of substrate that is adequate for carrying the electrical circuits, like a ceramic substrate, a silicon substrate, or a FR4 substrate, or any other type of circuit carrier substrate.

The first electric circuit may comprise a respective electrical connection pad i.e., the first electrical connection pad. The first electrical connection pad may be adapted to the size of the first connection section, or vice versa. Of course, the sizes may also be adapted according to the respective application, and the electrical signals to be processed in the respective application.

In embodiments, the first electric circuit, and the second electric circuit may be provided on the same substrate.

In another embodiment of the high-frequency waveguide module, which can be combined with all other embodiments mentioned above or below, the first electrical connection pad may electrically be coupled to the first connection section of the electrical interconnection element by at least one of bonding, ultrasonic bonding, soldering, and glueing.

For electrically coupling the first electrical connection pad to the first connection section, any adequate form of coupling may be used, and the high-frequency waveguide module is not limited to the above examples of bonding, ultrasonic bonding, soldering, and glueing.

In an embodiment of the high-frequency waveguide module, which can be combined with all other embodiments mentioned above or below, the first electric circuit and the first substrate together may form a Monolithic Microwave Integrated Circuit that comprises at least one of an amplifier, a mixer, a switch, a multiplier, an attenuator, a filter network, a low-pass filter, a high-pass filter, and a band-pass filter.

The first electric circuit may comprise any type of circuit. The MMIC or Monolithic Microwave Integrated Circuit is an example of a type of circuit that may be beneficially used with the electrical interconnection element in a high-frequency waveguide module.

In a further embodiment of the high-frequency waveguide module, which can be combined with all other embodiments mentioned above or below, the first electric circuit may further comprise an antenna structure, and a signal line that couples the antenna structure to the first electrical connection pad.

In embodiments, the first electric circuit may comprise at least in part a passive circuit, like an antenna structure with a signal line that couples the antenna structure to the respective first electrical connection pad. Of course, other electrical elements are possible

In another embodiment of the high-frequency waveguide module, which can be combined with all other embodiments mentioned above or below, the high-frequency waveguide module may further comprise a housing, wherein the housing may comprise a hollow waveguide, and wherein the antenna structure may be arranged in the hollow waveguide to transform an electromagnetic wave in the hollow waveguide into an electric signal on a signal line or vice versa.

Especially, when used in combination with a passive circuit element, like an antenna structure, the high-frequency waveguide module may comprise a housing that accommodates a hollow waveguide. The antenna structure may in such embodiments, be arranged in the hollow waveguide to receive signals from the hollow waveguide and convert the signals into electrical signals on the signal line. The antenna structure may also receive electrical signal via the signal line, and transmit these signals as electromagnetic waves in the hollow waveguide.

In an embodiment of the high-frequency waveguide module, which can be combined with all other embodiments mentioned above or below, the high-frequency waveguide module may further comprise a second substrate, wherein the second electric circuit may be arranged on the second substrate, wherein the second electric circuit may comprise a second electrical connection pad, and wherein the second electrical connection pad may electrically be coupled to the second connection section of the electrical interconnection element.

The explanations provided above for the first substrate apply mutatis mutandis to the second substrate.

The high-frequency waveguide module may comprise a dedicated substrate for the second electric circuit. The substrate may be any type of substrate that is adequate for carrying the electrical circuits, like a ceramic substrate, or a silicon substrate.

The second electric circuit may comprise a respective electrical connection pad i.e., the second electrical connection pad. The second electrical connection pad may be adapted to the size of the second connection section, or vice versa. Of course, the sizes may also be adapted according to the respective application, and the electrical signals to be processed in the respective application.

In embodiments, the first electric circuit, and the second electric circuit may be provided on the same substrate.

In a further embodiment of the high-frequency waveguide module, which can be combined with all other embodiments mentioned above or below, the second electrical connection pad may electrically be coupled to the second connection section of the electrical interconnection element by at least one of bonding, ultrasonic bonding, soldering, and glueing.

For electrically coupling the second electrical connection pad to the second connection section, any adequate form of coupling may be used, and the high-frequency waveguide module is not limited to the above examples of bonding, ultrasonic bonding, soldering, and glueing.

In another embodiment of the high-frequency waveguide module, which can be combined with all other embodiments mentioned above or below, the second electric circuit and the second substrate together may form a Monolithic Microwave Integrated Circuit that may comprise at least one of an amplifier, a mixer, a switch, a multiplier, an attenuator, a filter network, a low-pass filter, a high-pass filter, and a band-pass filter.

The second electric circuit may comprise any type of circuit. The MMIC or Monolithic Microwave Integrated Circuit is an example of a type of circuit that may be beneficially used with the electrical interconnection element in a high-frequency waveguide module.

In an embodiment of the high-frequency waveguide module, which can be combined with all other embodiments mentioned above or below, the high-frequency waveguide module may further comprises a first substrate, and a second substrate, wherein the first electric circuit may be arranged on the first substrate, wherein the first electric circuit may comprise a first electrical connection pad, wherein the first electrical connection pad may electrically be coupled to the first connection section of the electrical interconnection element, wherein the second electric circuit may be arranged on the second substrate, wherein the second electric circuit may comprise a second electrical connection pad, and wherein the second electrical connection pad is electrically coupled to the second connection section of the electrical interconnection element.

In the high-frequency waveguide module the first substrate with the first electric circuit, and the second substrate with the second electric circuit may be present. In such embodiments, the electrical interconnection element flexibly couples the first electrical connection pad of the first electric circuit to the second electrical connection pad of the second electric circuit.

In a further embodiment of the high-frequency waveguide module, which can be combined with all other embodiments mentioned above or below, the first electrical connection pad may be arranged at the same height as the second electrical connection pad, or at a different height as the second electrical connection pad.

With the electrical interconnection element, a first electrical connection pad, and a second first electrical connection pad may be coupled to each other easily. The first electrical connection pad, and the second electrical connection pad may be provided at the same height. In embodiments, the first electrical connection pad, and the second electrical connection pad may also be provided at different heights. The term height in this context refers to the displacement of the first electrical connection pad, and the second electrical connection pad relative to each other with regard to the normal of the plane defined by the first direction, and the second direction.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of an electrical interconnection element according to the present disclosure;

FIG. 2 shows a block diagram of another embodiment of an electrical interconnection element according to the present disclosure;

FIG. 3 shows a block diagram of a further embodiment of an electrical interconnection element according to the present disclosure;

FIG. 4 shows a block diagram of another embodiment of an electrical interconnection element according to the present disclosure;

FIG. 5 shows a block diagram of a further embodiment of an electrical interconnection element according to the present disclosure;

FIG. 6 shows a block diagram of an embodiment of a high-frequency waveguide module according to the present disclosure;

FIG. 7 shows a block diagram of another embodiment of a high-frequency waveguide module according to the present disclosure;

FIG. 8 shows a block diagram of an embodiment of an electrical apparatus according to the present disclosure; and

FIG. 9 shows a block diagram of another embodiment of an electrical apparatus according to the present disclosure.

In the figures like reference signs denote like elements unless stated otherwise.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

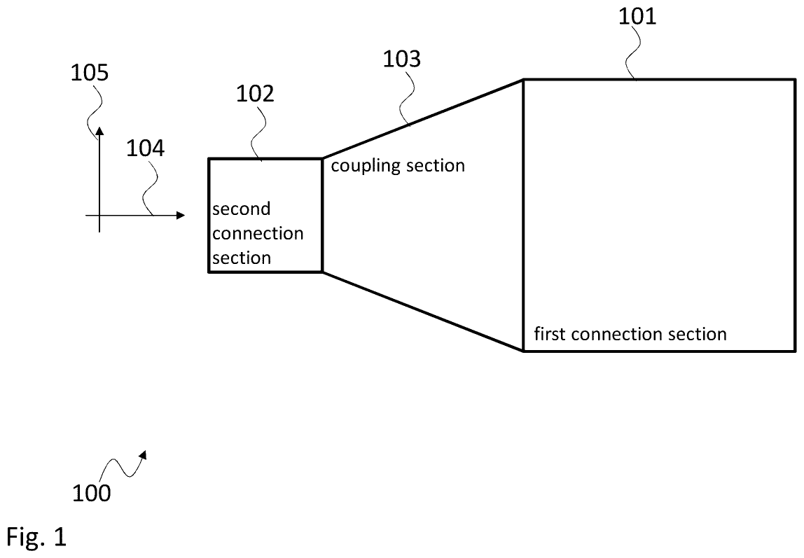

FIG. 1 shows an electrical interconnection element 100. The electrical interconnection element 100 comprises a first connection section 101 for electrically coupling to a first electric circuit (not shown), and a second connection section 102 for electrically coupling to a second electric circuit (not shown). The electrical interconnection element 100 further comprises a coupling section 103 arranged between the first connection section 101, and the second connection section 102.

The first connection section 101, the coupling section 103, and the second connection section 102 are arranged next to each other in a first, longitudinal direction 104 of the electrical interconnection element 100 (the horizontal direction in FIG. 1). The first connection section 101 is wider than the second connection section 102 in a second direction 105 (the vertical direction in FIG. 1) that is orthogonal to the first direction 104.

In the electrical interconnection element 100, the first connection section 101, the second connection section 102, and the coupling section 103 are aligned in the first direction 104, such that the three elements share a common center axis. In other embodiments, at least one of the first connection section 101, the second connection section 102, and the coupling section 103 may be displaced in the vertical direction.

The first connection section 101, the coupling section 103, and the second connection section 102 are electrically coupled to each other. This may be achieved by integrally forming the electrical interconnection element 100 from a single element of conductive material, or by fixing two or three single elements to each other e.g., by bonding, gluing, or soldering.

The electrical interconnection element 100, or the single elements i.e., the first connection section 101, the second connection section 102, and the coupling section 103, may be made of gold, aluminum or any other adequate conductive material, or a substrate covered with such a material.

The coupling section 103 in a plane defined by the first direction 104 and the second direction 105 (in the top view shown in FIG. 1) comprises a shape that narrows from the width of the first connection section 101 to the width of the second connection section 102. In the electrical interconnection element 100, the coupling section 103 comprises a trapezoidal shape.

The first connection section 101, and the second connection section 102 in the plane defined by the first direction 104 and the second direction 105 each comprise a square shape. As will be explained below referring to the further figures, other shapes are also possible.

In the electrical interconnection element 100 the first connection section 101, and the second connection section 102 are oriented in parallel and at the same height. The term height refers to the respective element being placed with regard to a third direction, which is orthogonal to the first direction 104, and the second direction 105.

In other embodiments, the first connection section 101, and the second connection section 102 may be placed at different heights. In such embodiments, the coupling section 103 may compensate the height difference between the first connection section 101, and the second connection section 102.

In the electrical interconnection element 100, the edges of the first connection section 101, and the second connection section 102 facing to each other are parallel to each other. In other embodiments, these edges may be rotated to each other. In such embodiments, the second connection section 102 compensates such a rotation and is respectively shaped.

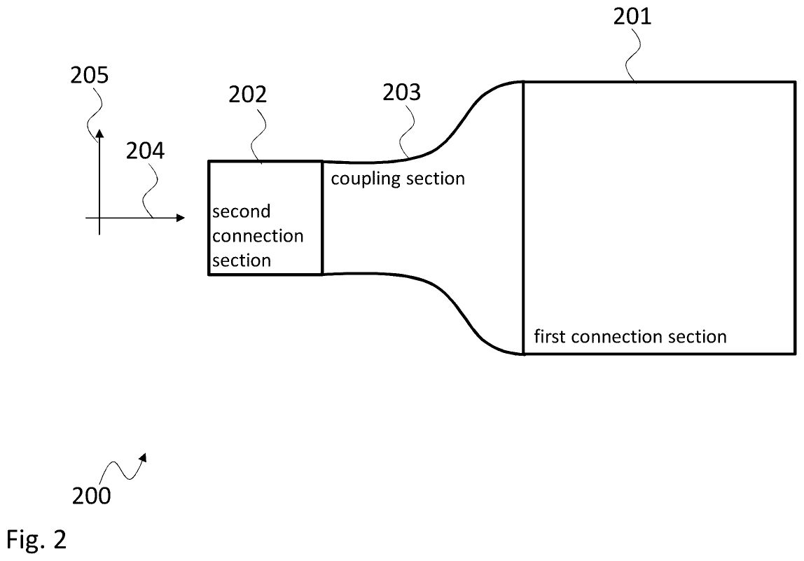

FIG. 2 shows an electrical interconnection element 200. The electrical interconnection element 200 is based on the electrical interconnection element 100. Therefore, the electrical interconnection element 200 comprises a first connection section 201 for electrically coupling to a first electric circuit (not shown), and a second connection section 202 for electrically coupling to a second electric circuit (not shown). The electrical interconnection element 200 further comprises a coupling section 203 arranged between the first connection section 201, and the second connection section 202. The explanations provided herein for any one of the other embodiments of the electrical interconnection element apply to the electrical interconnection element 200 mutatis mutandis.

In the electrical interconnection element 200, the coupling section 203 in a plane defined by the first direction 204 and the second direction 205 (in the top view shown in FIG. 1) comprises a shape that narrows from the width of the first connection section 201 to the width of the second connection section 202. In contrast to the electrical interconnection element 100, in the electrical interconnection element 200, the coupling section 203 comprises curved edges between the first connection section 201, and the second connection section 202.

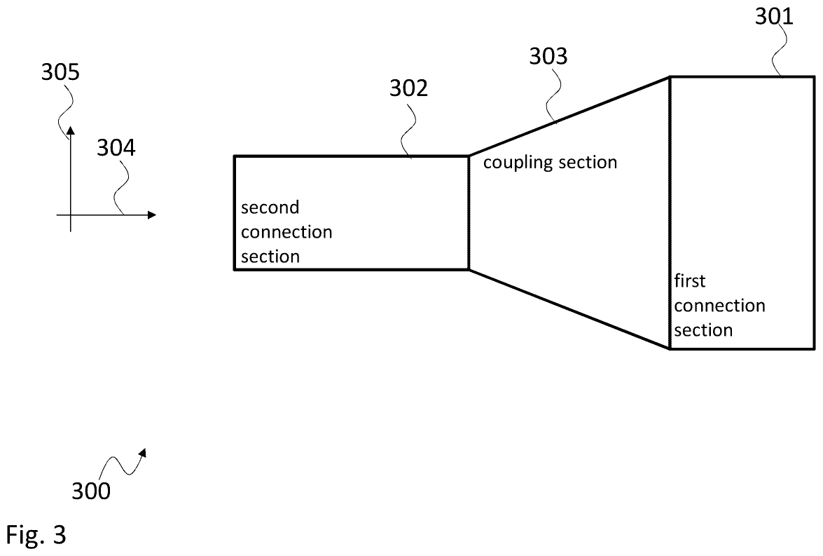

FIG. 3 shows an electrical interconnection element 300. The electrical interconnection element 300 is based on the electrical interconnection element 100. Therefore, the electrical interconnection element 300 comprises a first connection section 301 for electrically coupling to a first electric circuit (not shown), and a second connection section 302 for electrically coupling to a second electric circuit (not shown). The electrical interconnection element 300 further comprises a coupling section 303 arranged between the first connection section 301, and the second connection section 302. The explanations provided herein for any one of the other embodiments of the electrical interconnection element apply to the electrical interconnection element 300 mutatis mutandis.

In contrast to the electrical interconnection element 100, in the electrical interconnection element 300, the first connection section 301, and the second connection section 302 are not square shaped, but each comprise a rectangular shape. The first connection section 301 is higher than it is wide, while the second connection section 302 is wider than it is high.

It is understood, that in other embodiments, the first connection section 301 may be wider than it is high, and the second connection section 302 may be higher than it is wide.

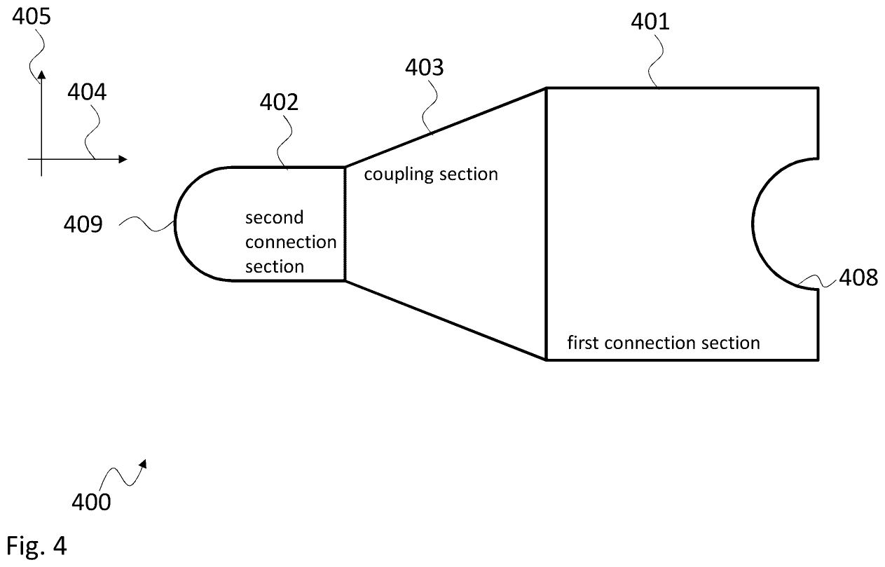

FIG. 4 shows an electrical interconnection element 400. The electrical interconnection element 400 is based on the electrical interconnection element 100. Therefore, the electrical interconnection element 400 comprises a first connection section 401 for electrically coupling to a first electric circuit (not shown), and a second connection section 402 for electrically coupling to a second electric circuit (not shown). The electrical interconnection element 400 further comprises a coupling section 403 arranged between the first connection section 401, and the second connection section 402. The explanations provided herein for any one of the other embodiments of the electrical interconnection element apply to the electrical interconnection element 400 mutatis mutandis.

In contrast to the electrical interconnection elements 100, 200, and 300, in the electrical interconnection element 400 the first connection section 401, and the second connection section 402 neither comprise a square shape nor a rectangular shape.

Instead, the first connection section 401 comprises a half-circle-shaped recess on the edge that is opposite to the coupling section 403. The second connection section 402 comprises a half-circle-shaped protrusion on the edge that is opposite to the coupling section 403. In other embodiments, more recesses and protrusions may be provided on the first connection section 401, and the second connection section 402. Such recesses and protrusions may be provided on any one of the edges of the first connection section 401, and the second connection section 402.

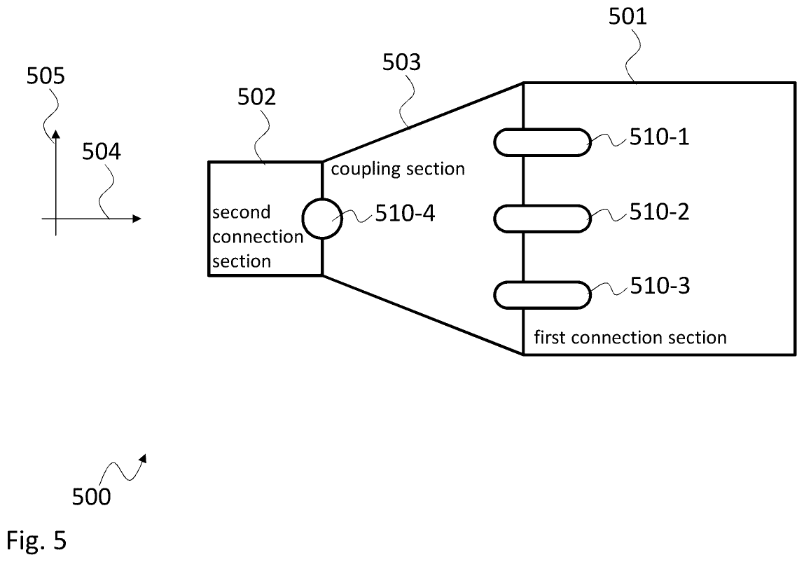

FIG. 5 shows an electrical interconnection element 500. The electrical interconnection element 500 is based on the electrical interconnection element 100. Therefore, the electrical interconnection element 500 comprises a first connection section 501 for electrically coupling to a first electric circuit (not shown), and a second connection section 502 for electrically coupling to a second electric circuit (not shown). The electrical interconnection element 500 further comprises a coupling section 503 arranged between the first connection section 501, and the second connection section 502. The explanations provided herein for any one of the other embodiments of the electrical interconnection element apply to the electrical interconnection element 500 mutatis mutandis.

Further, the electrical interconnection element 500 comprises openings or holes on its surface. Three vertical slots or vertically slotted holes 510-1, 510-2, 510-3 are provided from the first connection section 501 to the coupling section 503. Further, a circular hole 510-4 is provided between the second connection section 502, and the coupling section 503.

The arrangement of the electrical interconnection element 500 shows an exemplary embodiment. In other embodiments, slots and holes or other types of openings may be provided in the electrical interconnection element as adequate for the respective application. The specific sizes, shapes, and positions of such openings may be determined e.g., by simulation.

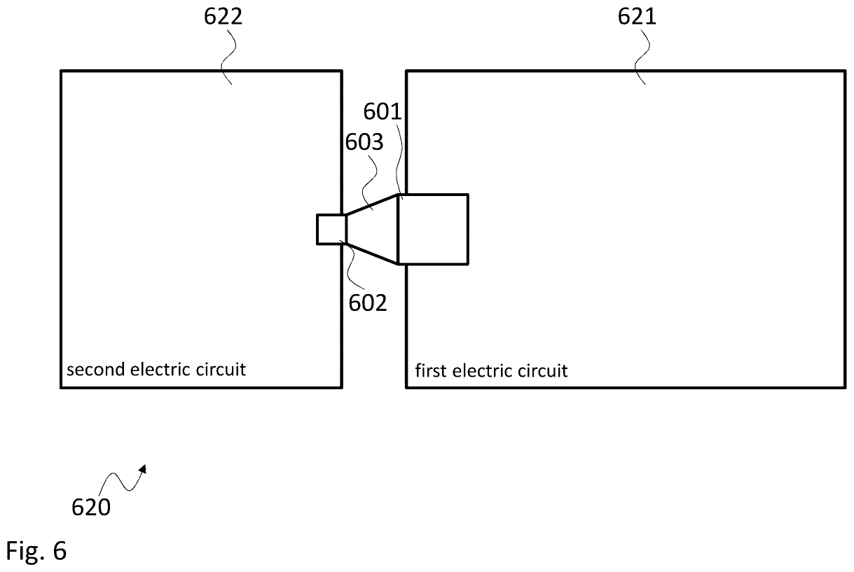

FIG. 6 shows a high-frequency waveguide module 620. The high-frequency waveguide module 620 comprises a first electric circuit 621, and a second electric circuit 622 arranged in a predefined distance from the first electric circuit 620. Further, the high-frequency waveguide module 620 comprises an electrical interconnection element. The electrical interconnection element may be an electrical interconnection element according to any one of the embodiments disclosed herein. In the high-frequency waveguide module 620, the electrical interconnection element exemplarily comprises a first connection section 601 that is electrically coupled to the first electric circuit 621, and a second connection section 602 that is electrically coupled to the second electric circuit 622. Further, a coupling section 603 is provided between the first connection section 601, and the second connection section 602. The first connection section 601, and the second connection section 602 each comprise a square shape, wherein the surface of the first connection section 601 is larger than the surface of the second connection section 602. In embodiments, the sizes and shapes shown exemplarily for the first connection section 601, the second connection section 602, and the coupling section 603 may be different.

With the electrical interconnection element, the first electric circuit 621, and the second electric circuit 622 may easily be coupled to each other electrically with a connection that provides an improved impedance matching between the first electric circuit 621, and the second electric circuit 622, that reduces the reflection losses, and that reduces standing waves.

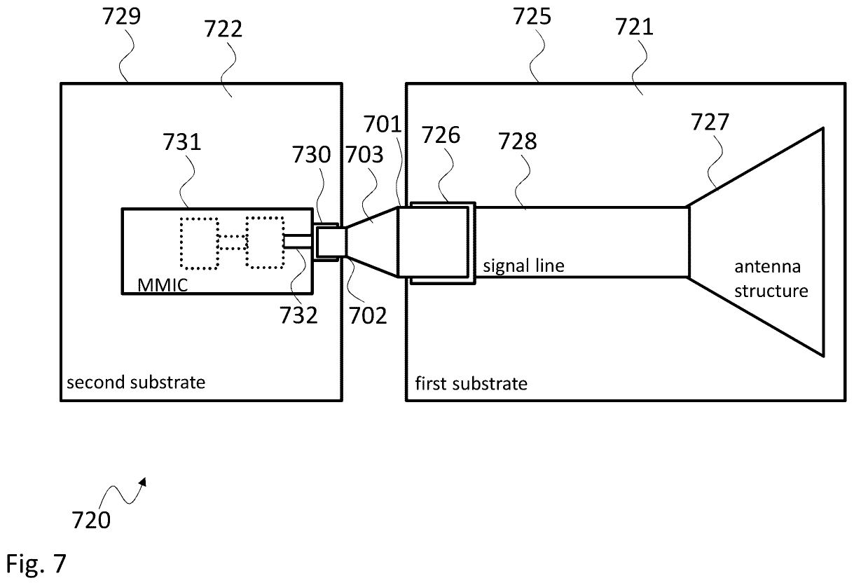

FIG. 7 shows a high-frequency waveguide module 720. The high-frequency waveguide module 720 is based on the high-frequency waveguide module 620. Therefore, the high-frequency waveguide module 720 comprises a first electric circuit 721, and a second electric circuit 722 arranged in a predefined distance from the first electric circuit 720. Further, the high-frequency waveguide module 720 comprises an electrical interconnection element. The electrical interconnection element may be an electrical interconnection element according to any one of the embodiments disclosed herein. In the high-frequency waveguide module 720, the electrical interconnection element exemplarily comprises a first connection section 701 that is electrically coupled to the first electric circuit 721, and a second connection section 702 that is electrically coupled to the second electric circuit 722. Further, a coupling section 703 is provided between the first connection section 701, and the second connection section 702. The first connection section 701, and the second connection section 702 each comprise a square shape, wherein the surface of the first connection section 701 is larger than the surface of the second connection section 702. The explanations provided herein for any one of the other embodiments of the high-frequency waveguide module apply to the high-frequency waveguide module 720 mutatis mutandis.

The high-frequency waveguide module 720 further comprises a first substrate 725, wherein the first electric circuit 721 is arranged on the first substrate 725. The first electric circuit 721 comprises an antenna structure 727, and a signal line 728 that couples the antenna structure 727 to a first electrical connection pad 726. The first electrical connection pad 726 is electrically coupled to the first connection section 701 of the electrical interconnection element.

The high-frequency waveguide module 720 further comprises a second substrate 729, wherein the second electric circuit 722 is arranged on the second substrate 729. The second electric circuit 722 comprises a second electrical connection pad 730 that is electrically coupled to the second connection section 702 of the electrical interconnection element. The second electric circuit 722 further comprises a MMIC 731 that comprises at least one circuit element 732. Possible circuit elements 732 comprise, but are not limited to an amplifier, a mixer, a switch, a multiplier, an attenuator, a filter network, a low-pass filter, a high-pass filter, and a band-pass filter.

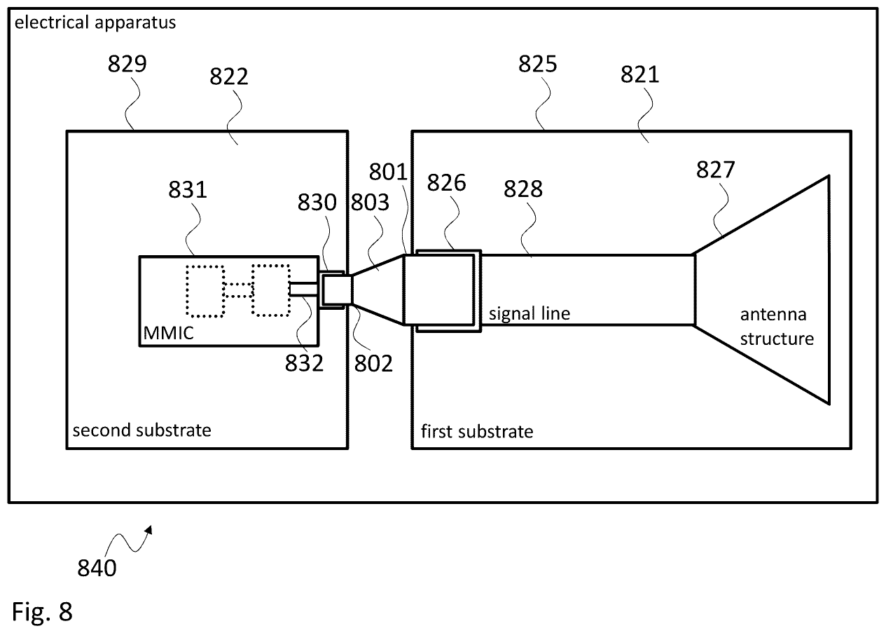

FIG. 8 shows a block diagram of an electrical apparatus 840. The electrical apparatus 840 comprises a high-frequency waveguide module, for example, a high-frequency waveguide module 620 or high-frequency waveguide module 720 as explained above. The electrical apparatus 840 may comprise a high-frequency waveguide module according to any one of the embodiments disclosed herein.

The electrical apparatus 840 may be at least one of a satellite, a radiometer, a microwave transmitter, and a microwave receiver.

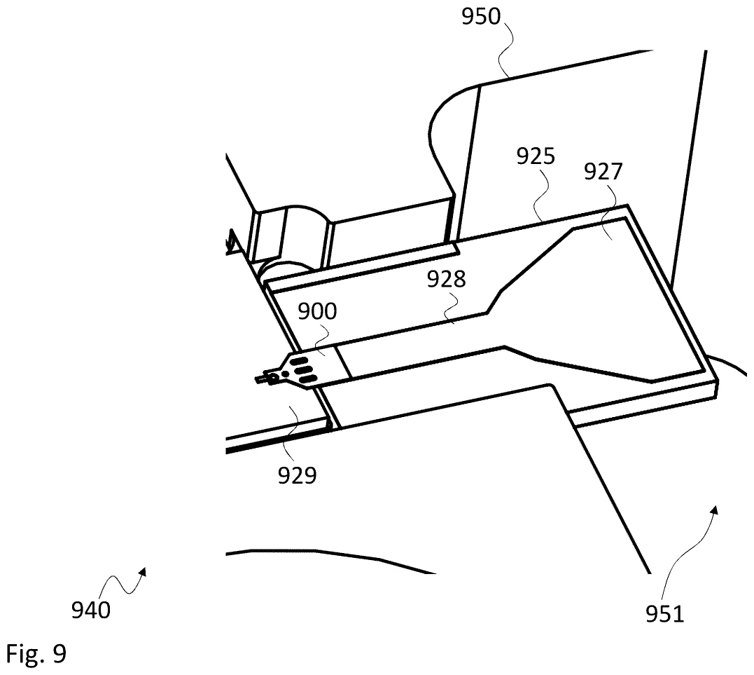

FIG. 9 shows a diagram of another electrical apparatus 940. The explanations provided herein for any one of the other embodiments of the electrical apparatus apply to the electrical apparatus 940 mutatis mutandis.

The electrical apparatus 940 is based on the electrical apparatus 840, and comprises a high-frequency waveguide module with a first substrate 925, and a second substrate 929. The first substrate 925 carries a first electric circuit with an antenna structure 927, that is coupled to an electrical interconnection element 900 via a signal line 928. The second substrate 929 carries a respective electrical circuit (not explicitly shown).

The electrical apparatus 940 further comprises a housing 950 that forms or provides a hollow waveguide 951. The housing 950 is formed such that the first substrate 925 extends into the hollow waveguide 951 such that the antenna structure 927 reaches into the hollow waveguide 951. This allows receiving or transmitting wireless electromagnetic signals with the antenna structure 927 from or into the hollow waveguide 951.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

100, 200, 300, 400, 500 electrical interconnection element
101, 201, 301, 401, 501, 601, 701, 801 first connection section
102, 202, 302, 402, 502, 602, 702, 802 second connection section
103, 203, 303, 403, 503, 603, 703, 803 coupling section
104, 204, 304, 404, 504 first direction
105, 205, 305, 405, 505 second direction
408, 409 curved contour
510-1, 510-2, 510-3, 510-4 opening
620, 720 high-frequency waveguide module
621, 721, 821 first electric circuit
622, 722, 822 second electric circuit
725, 825, 925 first substrate
726, 826 first electrical connection pad
727, 827, 927 antenna structure
728, 828, 928 signal line
729, 829, 929 second substrate
730, 830 second electrical connection pad
731, 831 Monolithic Microwave Integrated Circuit
732, 832 circuit element
840, 940 electrical apparatus
950 housing
951 hollow waveguide

What is claimed is:

1. An electrical interconnection element comprising:
a first connection section for electrically coupling to a first electric circuit;
a second connection section for electrically coupling to a second electric circuit; and
a coupling section;
wherein the first connection section, the coupling section, and the second connection section are arranged next to each other in a first, longitudinal direction of the electrical interconnection element, and are electrically coupled to each other; and
wherein the first connection section in a second direction that is orthogonal to the first direction is wider than the second connection section in the second direction.

2. The electrical interconnection element according to claim 1, wherein the coupling section in a plane defined by the first direction and the second direction comprises a shape that narrows from the width of the first connection section to the width of the second connection section.

3. The electrical interconnection element according to claim 1, wherein the coupling section in a plane defined by the first direction and the second direction comprises a trapezoidal shape, or a shape with curved edges from the first connection section to the second connection section.

4. The electrical interconnection element according to claim 1, wherein the first connection section, and the second connection section in a plane defined by the first direction and the second direction each comprise a square shape, or a rectangular shape.

5. The electrical interconnection element according to claim 1, wherein:
the first connection section is electrically coupled to the second connection section by at least one of bonding, ultrasonic bonding, soldering, and gluing; and
the second connection section is electrically coupled to the coupling section by at least one of bonding, ultrasonic bonding, soldering, and gluing.

6. The electrical interconnection element according to claim 1, comprising a single electrically conductive element that accommodates the first connection section, the second connection section, and the coupling section.

7. The electrical interconnection element according to claim 1, wherein the electrical interconnection element is at least one of:
integrally formed;
formed of gold, or aluminum; and
formed by a photolithographic process.

8. A high-frequency waveguide module comprising:
a first electric circuit;
a second electric circuit arranged in a predefined distance from the first electric circuit; and
an electrical interconnection element;
the electrical interconnection element comprising:
a first connection section electrically coupled to the first electric circuit;
a second connection section electrically coupled to the second electric circuit; and
a coupling section;
wherein the first connection section, the coupling section, and the second connection section are arranged next to each other in a first, longitudinal direction of the electrical interconnection element, and are electrically coupled to each other; and
wherein the first connection section in a second direction that is orthogonal to the first direction is wider than the second connection section in the second direction.

9. The high-frequency waveguide module according to claim 8, further comprising:
a first substrate;
wherein the first electric circuit is arranged on the first substrate;
wherein the first electric circuit comprises a first electrical connection pad; and
wherein the first electrical connection pad is electrically coupled to the first connection section of the electrical interconnection element.

10. The high-frequency waveguide module according to claim 9, wherein the first electrical connection pad is electrically coupled to the first connection section of the electrical interconnection element by at least one of bonding, ultrasonic bonding, soldering, and gluing.

11. The high-frequency waveguide module according to claim 9, wherein the first electric circuit and the first substrate together form a Monolithic Microwave Integrated Circuit that comprises at least one of an amplifier, a mixer, a switch, a multiplier, an attenuator, a filter network, a low-pass filter, a high-pass filter, and a band-pass filter.

12. The high-frequency waveguide module according to claim 9, wherein the first electric circuit further comprises an antenna structure, and a signal line that couples the antenna structure to the first electrical connection pad.

13. The high-frequency waveguide module according to claim 12, further comprising a housing;
wherein the housing comprises a hollow waveguide, and wherein the antenna structure is arranged in the hollow waveguide to transform an electromagnetic wave in the hollow waveguide into an electric signal on signal line or vice versa.

14. The high-frequency waveguide module according to claim 8, further comprising:
a second substrate;
wherein the second electric circuit is arranged on the second substrate;
wherein the second electric circuit comprises a second electrical connection pad; and
wherein the second electrical connection pad is electrically coupled to the second connection section of the electrical interconnection element.

15. The high-frequency waveguide module according to claim 14, wherein the second electrical connection pad is electrically coupled to the second connection section of the electrical interconnection element by at least one of bonding, ultrasonic bonding, soldering, and gluing.

16. The high-frequency waveguide module according to claim 14, wherein the second electric circuit and the second substrate together form a Monolithic Microwave Integrated Circuit that comprises at least one of an amplifier, a mixer, a switch, a multiplier, an attenuator, a filter network, a low-pass filter, a high-pass filter, and a band-pass filter.

17. The high-frequency waveguide module according to claim 8, further comprising:
a first substrate; and
a second substrate;
wherein the first electric circuit is arranged on the first substrate;
wherein the first electric circuit comprises a first electrical connection pad;
wherein the first electrical connection pad is electrically coupled to the first connection section of the electrical interconnection element;
wherein the second electric circuit is arranged on the second substrate;
wherein the second electric circuit comprises a second electrical connection pad; and
wherein the second electrical connection pad is electrically coupled to the second connection section of the electrical interconnection element.

18. The high-frequency waveguide module according to claim 17, wherein the first electrical connection pad is arranged at the same height as the second electrical connection pad, or at a different height as the second electrical connection pad.

19. The high-frequency waveguide module according to claim 17, further comprising:
at least one of a radiometer coupled to the second electric circuit, a microwave transmitter coupled to the second electric circuit, and a microwave receiver coupled to the second electric circuit.

20. An electrical apparatus comprising:
a first electric circuit;
a second electric circuit arranged in a predefined distance from the first electric circuit; and
an electrical interconnection element;
the electrical interconnection element comprising:
a first connection section electrically coupled to the first electric circuit;
a second connection section electrically coupled to the second electric circuit; and
a coupling section;
wherein the first connection section, the coupling section, and the second connection section are arranged next to each other in a first, longitudinal direction of the electrical interconnection element, and are electrically coupled to each other; and
wherein the first connection section in a second direction that is orthogonal to the first direction is wider than the second connection section in the second direction;
the electrical apparatus further comprising:
a first substrate; and
a second substrate;
wherein the first electric circuit is arranged on the first substrate;
wherein the first electric circuit comprises a first electrical connection pad;
wherein the first electrical connection pad is electrically coupled to the first connection section of the electrical interconnection element;
wherein the second electric circuit is arranged on the second substrate;
wherein the second electric circuit comprises a second electrical connection pad; and
wherein the second electrical connection pad is electrically coupled to the second connection section of the electrical interconnection element.

21. The electrical apparatus according to claim 20, wherein the electrical apparatus is at least one of a satellite, a radiometer, a microwave transmitter, and a microwave receiver.
